(19) United States
(12) Patent Application Publication
(10) Pub. No.: US 2012/0317213 A1
(43) Pub. Date: Dec. 13, 2012

(54) TRANSMITTING INSTANT MESSAGES

(75) Inventor: Jian Zhang, Hangzhou (CN)

(73) Assignee: ALIBABA GROUP HOLDING LIMITED, George Town (KY)

(21) Appl. No.: 13/489,376

(22) Filed: Jun. 5, 2012

(30) Foreign Application Priority Data
Jun. 8, 2011 (CN) 201110151732.7

(51) Int. Cl. G06F 15/16

(52) U.S. Cl. 709/206

(57) ABSTRACT

Transmitting instant messaging (IM) messages is disclosed, including: receiving an instant messaging (IM) message including a recipient IM account identifier, wherein the recipient IM account identifier comprises a main account identifier; determining that the recipient IM account identifier is not logged on; determining whether the recipient IM account identifier is associated with a sub-account identifier; in the event that the recipient IM account identifier is associated with a sub-account identifier, determining whether the sub-account identifier is logged on; and in the event that the sub-account identifier is logged on, sending the IM message to the sub-account identifier and sending identifying information of the sub-account identifier associated with receiving the IM message to an IM account identifier associated with sending the IM message.

### CROSS REFERENCE TO OTHER APPLICATIONS

This application claims priority to People's Republic of China Patent Application No. 201110151732.7 entitled A METHOD AND EQUIPMENT FOR TRANSMITTING IM MESSAGES filed Jun. 8, 2011 which is incorporated herein by reference for all purposes.

### FIELD OF THE INVENTION

The present application relates to the field of communications. In particular, it relates to a technique for transmitting instant messaging (IM) messages.

### BACKGROUND OF THE INVENTION

Instant messaging (IM) is a service whereby messages can be promptly sent between senders and receivers. IM messages may be transmitted over a network, such as the Internet. As IM has developed in the last few years, its uses have expanded. For example, an IM service may integrate multiple functions, such as e-mail, blogging, music sharing, video sharing, games, and searches. IM services may also serve as a total information platform that integrates exchanges, information, entertainment, searches, e-commerce, office work collaboration, and corporate customer services, for example.

In some existing systems, IM services operate as follows: the user connects to an IM server through an IM client application installed at a device (e.g., a computer). The user is associated with an IM account number that is registered and allocated to the user at an IM server that hosts the IM service. The user logs on to the IM service using a username and associated password associated with the IM account to transmit IM messages with other logged on IM users.

In some existing systems, the IM account numbers that are allocated for users by the IM server may include two types: main account numbers and sub-account numbers. Main account numbers are administrative account numbers and in some instances, may have more privileges than sub-account numbers. After an IM server allocates a main account number to a user, the user may request for one or more sub-account numbers to be created under this main account number. While a main account number may or may not be associated with a sub-account number, each sub-account number is always associated with and administered by a main account number.

The following is an example process of sending an IM message to an IM account number that comprises a main account number that may or may not be associated with a sub-account number:

First, the sender IM client sends an IM message to the IM server. This IM message includes the username of the recipient IM account number and the contents of the IM message. Typically, the recipient IM account number comprises a main account number.

Second, after the IM server receives said IM message, the IM server extracts the recipient IM account number and username. The IM server uses the extracted username and/or IM account number to query another server, the online server. Generally, when a user logs on to the IM server using an IM account number at an IM client device, the IM server will learn the routing address of the device where this IM client is located and it will store the correspondence between the IM account number and the routing address at the online server. The online server then stores the correspondences between each IM account number (whether it is a main account number or a sub-account number) whose user is currently logged on and the client routing address used by this IM account number. Returning to the example, the online server then determines the routing address of the device that was used by the user associated with the recipient IM account number when the recipient user logged on to the IM server. However, if it is determined that no users are currently logged on via the recipient IM account number (i.e., a main account number), then the process ends and the IM message is not promptly delivered to either the main account number or any sub-account numbers, if there are any.

Third, the IM server next queries another server, the allocation server, to determine whether the recipient IM account number that is currently logged on is associated with any sub-account numbers. When the IM server creates one or more sub-account numbers for an existing main account number, the correspondence between this main account number and the sub-account number(s) will be recorded at the allocation server. Returning to the example, if the allocation server determines that the recipient IM account number is a main account number that is not associated with one or more sub-account numbers, then the IM message is sent to only the device associated with the recipient IM account number and the process ends. However, if the allocation server determines that the recipient IM account number is a main account number that is associated with one or more sub-account numbers, then the further steps below are performed:

Fourth, in the event that is determined that the recipient IM account number is a main account number that is associated with one or more sub-account number(s), the IM server continues querying the online server to determine the routing address of a device used by a user associated with a sub-account number when the user logged on to the IM server.

Fifth, using the routing addresses of the main account number and the sub-account number, the IM server then sends the IM message to both the client device associated with the main account number (i.e., the recipient IM account number) and also the client device associated with the sub-account number of the recipient IM account number. Sometimes, the IM server can simultaneously transmit IM messages to the main account number and an associated sub-account number such that the users at the main account number and the sub-account number may receive the same IM message at approximately the same time.

However, in the above-described example where the main account number and the sub-account number jointly receive the same IM message that is sent to the main account number, the recipient's main account number must be an IM account number that is logged on when the IM message is sent by the sender. This is because, as explained in the example above, the routing address of a main account number is available at the online server only when a user of the main account number has logged on, and if it is determined that the main account number is not logged on, the sub-account number(s) of the main account number are not queried for by the IM server. Thus, in this example, when no users are logged on using the main account number, even if a user is logged on using an associated sub-account number, neither the main account number nor the sub-account number can receive incoming messages sent to the main account number.

### BRIEF DESCRIPTION OF THE DRAWINGS

Various embodiments of the invention are disclosed in the following detailed description and the accompanying drawings.

FIG. 1 is a diagram showing an embodiment of a system for transmitting IM messages to an IM account identifier.

FIG. 2 is a flow diagram showing an embodiment of a process for transmitting IM messages to an IM account identifier.

FIG. 3 is a diagram showing an embodiment of a system for transmitting IM messages to an IM account identifier.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, an “IM account identifier” refers to an identifier assigned to a particular user once the user registers for an account at the IM service. There are two types of IM accounts; one is a main account identifier and the other is the sub-account identifier. While a main account identifier may exist without any sub-account identifiers, a sub-account identifier may only be created under an existing main account identifier. In some embodiments, an IM message sent to the main account identifier may also be received by the associated sub-account identifiers at substantially similar times. In some embodiments, an IM account identifier may be a unique identifier. For example, the IM account identifier may comprise an alphanumeric string and/or username. In some embodiments, the logon process is the same regardless if a user logs on via a main account identifier or a sub-account identifier. For a user to log on to the IM service, the user may use an IM client application installed at a device to issue a logon request to the IM system. The logon request may include the IM account identifier, an associated password, and/or a routing address associated with the device on which the software application (i.e., the IM client) used to log on is installed. Once the IM system authenticates the IM account identifier and associated password, a successful response message is sent back to the user via the IM client. Thereafter, the user may conduct IM operations via the logged on IM account identifier, such as, for example, sending and receiving IM messages with other IM account identifiers. However, in some embodiments, once the logon process is completed, a user logged on via a main account identifier may have more privileges to perform IM operations than a user logged on via a sub-account identifier depending on any one or more rules configured by the user that set up the main account identifier. In some embodiments, the main account identifier may be notified of an IM message sent from a sub-account identifier.

As used herein, the “client” refers to the IM software application client installed at a device. Each device on which the IM client is installed may be identified/reached by a corresponding routing address.

As used herein, the “logged on” status refers to when a user has successfully logged on to the IM service and the “not logged on” status refers to when a user has not yet or is no longer logged on to the IM service.

Transmitting IM messages to an IM account identifier is described herein. In various embodiments, even if it is determined a main account identifier to which an IM message is sent is not currently logged on, the IM message may still be promptly transmitted to a device associated with a sub-account identifier that is currently logged on. In some embodiments, even if no users associated with a main account identifier are currently logged on to an IM server, a user associated with a sub-account identifier may promptly receive an IM message that was sent to the main account identifier. In various embodiments, in the event that the main account identifier is not logged on and the IM message is sent to an associated, logged on sub-account identifier, the user that sent the IM message is notified that the recipient of the IM message is actually a user associated with a sub-account identifier of the main account identifier to which the IM message was intended, instead of a user associated with the main account identifier.

For example, a main account identifier under the described IM service may be created by a user Alice for primarily her own use. Alice may be a store owner who would like to use the IM service to conveniently communicate with her customers. Alice may also create a sub-account identifier under her main account identifier for her assistant to use such that the assistant may also be able to receive and/or send IM messages to inquiring customers via the IM service. While Alice may prefer to answer all customer IM communication herself, sometimes she is too busy or is otherwise not available to log on to the IM service. By virtue of the IM service described herein, Alice's assistant may be able to receive and/or send messages on behalf of or instead of Alice while she is unavailable and/or not logged on to the service. If Alice and her assistant are using different devices, so long as the assistant's device is available to log on to the IM service, then the assistant may receive IM messages through his own device even if Alice's device is turned off or otherwise not in a state to log on to the IM service. In the event that Alice is not logged on and it is her assistant who is currently logged on who receives an IM message intended for Alice, the sender user of the IM message is notified that Alice's assistant is the user who has received the IM message instead of Alice herself. This way, the sender user is made aware of who is the actual recipient of his/her IM message and may adjust the communication to the recipient as desired.

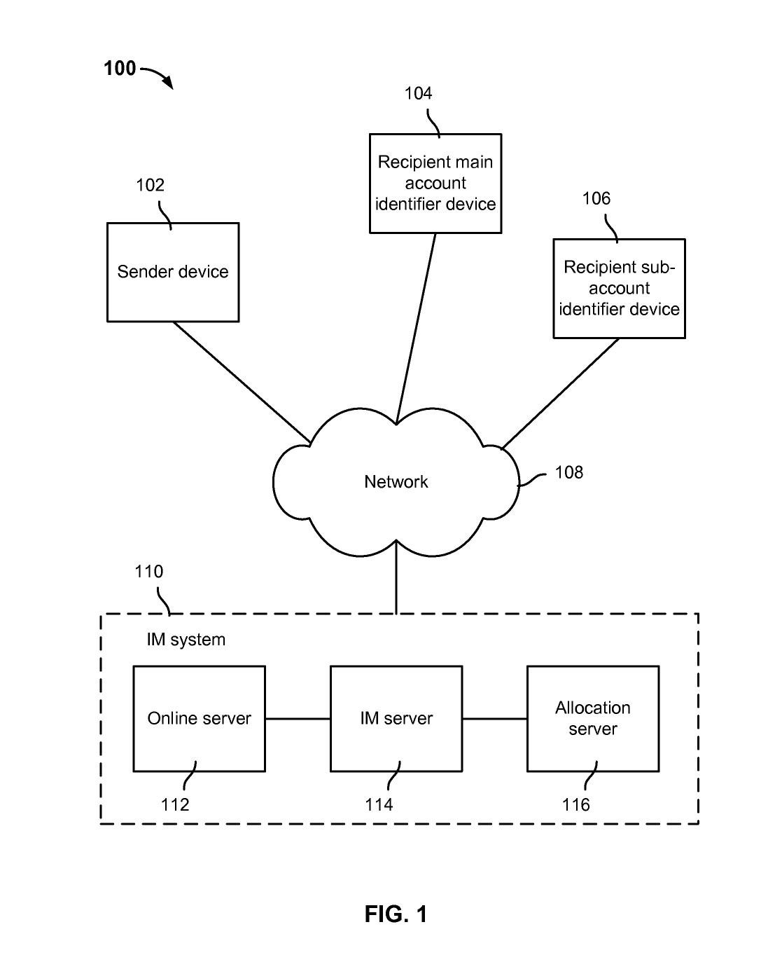

FIG. 1 is a diagram showing an embodiment of a system for transmitting IM messages to an IM account identifier. System 100 includes sender device 102, recipient main account identifier device 104, recipient sub-account identifier device 106, network 108, and IM system 110. IM system 110 includes online server 112, IM server 114, and allocation server 116. Online server 112, IM server 114, and allocation server 116 may be configured as a single device or across multiple devices. Network 108 may include high-speed data networks and/or telecommunications networks.

IM system 110 is configured to host an IM service that a user registered with the service may use to send and receive IM messages with another registered user of the service. Registered users are users with either IM main account identifiers or IM sub-account identifiers. In some embodiments, a user may register with the service by completing a form (e.g., and providing some personal information) provided by IM server 114. After successful registration with the service, IM server 114 provides the user with an IM account identifier that is a main account identifier. If the user chooses, the user may request IM server to create one or more sub-account identifiers under the user's main account identifier. In some embodiments, the user of the main account identifier may also configure one or more rules that dictate the IM messaging privileges of the main account identifier and/or each of the sub-account identifiers. The user may assign each sub-account identifier to another different user. For example, if the user with the main account were a store owner, then the store owner may assign each sub-account identifier to a different employee of his.

IM server 114 is configured to determine whether an IM account identifier has logged on and or logged off. In the event that IM server 114 determines that an IM account identifier has logged on, IM server 114 is configured to indicate to online server 112 that the IM account has logged on at a device associated with the routing address determined by IM server 114. Online server 112 is configured to record the correspondence between the logged on IM account identifier and the associated routing address. In the event that IM server 114 determines that an IM account identifier has logged off, IM server 114 is configured to indicate to online server 112 that the IM account has logged off from the device associated with the routing address determined by IM server 114. Online server 112 is configured to delete the correspondence between the now logged off IM account identifier and the associated routing address. In this way, online server 112 records up-to-date correspondences between those IM account identifiers that are currently online and their respective routing addresses.

IM server 114 is configured to create main account identifiers and also sub-account identifiers at the request of the user associated with a main account identifier. When IM server 114 creates a main account identifier, IM server 114 indicates to allocation server 116 that a main account identifier has been created and allocation server 116 records the existence of the main account identifier. When IM server 114 creates a sub-account identifier under an existing main account identifier, IM server 114 indicates to allocation server 116 that such a sub-account identifier has been created and allocation server 116 records the correspondence between the newly created sub-account identifier and its associated main account identifier. In this way, IM server 114 records up-to-date correspondences between main account identifiers and their associated sub-account identifiers.

Sender device 102, recipient main account identifier device 104, and recipient sub-account identifier device 106 are each client devices at which IM messages may be sent and received. In some embodiments, an IM client software application used to communicate with IM system 110 over network 108 is installed on each of sender device 102, recipient main account identifier device 104, and recipient sub-account identifier device 106. Each of sender device 102, recipient main account identifier device 104, and recipient sub-account identifier device 106 may be a laptop computer, a desktop computer, a mobile device, a tablet device, a smart phone, or any other type of computing device.

For example, a different user may be using each of sender device 102, recipient main account identifier device 104, and recipient sub-account identifier device 106. Recipient main account identifier device 104 may be used by a user associated with a main account identifier and recipient sub-account identifier device 106 may be used by a user associated with a sub-account identifier corresponding to the main account identifier of device 104. As will be further explained below, a user using the IM service at sender device 102 may send an IM message to the IM account identifier associated with the main account identifier of recipient main account identifier device 104. The IM message may be received and processed by IM system 110. However, if IM system 110 determines that the user at recipient main account identifier device 104 is not currently logged on but the user at recipient sub-account identifier device 106 was currently logged on when the IM message was sent by sender device 102, then IM system 110 may forward the IM message to recipient sub-account identifier device 106 instead of the recipient main account identifier device 104 so that the user of the sub-account identifier may promptly receive the IM message even if the intended recipient of the main account identifier is not available.

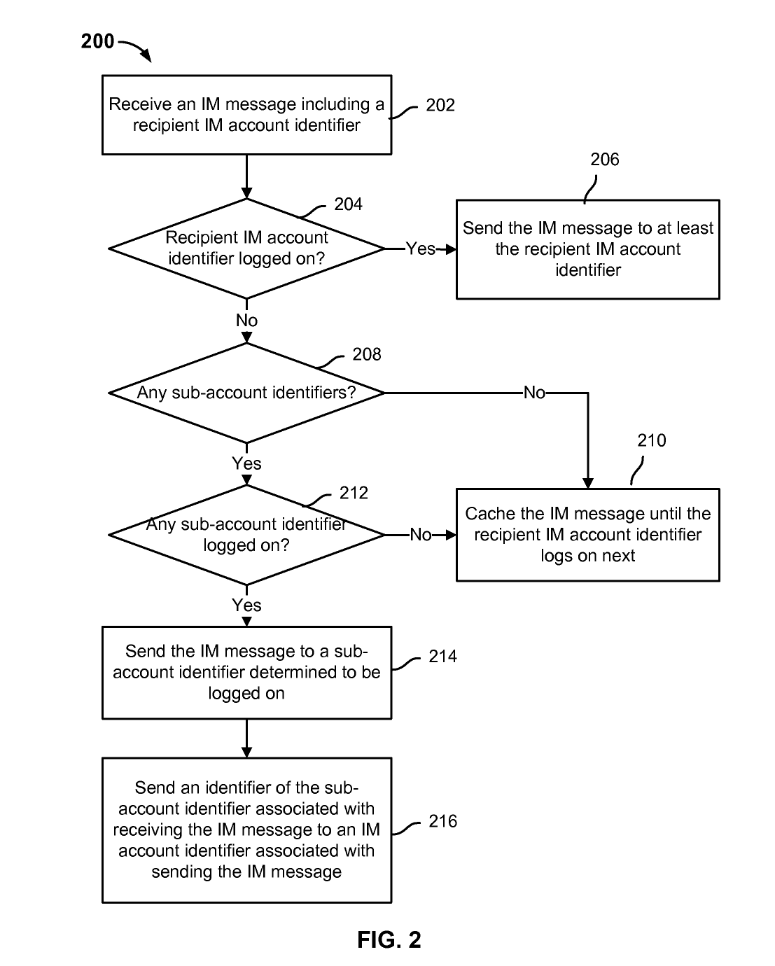

FIG. 2 is a flow diagram showing an embodiment of a process for transmitting IM messages to an IM account identifier. In some embodiments, process 200 may be implemented at an IM system such as IM system 110 of system 100.

At 202, an IM message including a recipient IM account identifier is received, wherein the recipient IM account identifier comprises a main account identifier. A user may log on to the IM service using his/her logon information to transmit an IM message to another user identified by the recipient IM account identifier. In some embodiments, once the sender user logs on to the IM service, information related to the sender user's IM account identifier may be displayed, including the sender user's contact information, and the length of the time that the user has been online, for example. The recipient IM account identifier is also a main account identifier that is associated with a particular user, who may be different from a user associated with a sub-account identifier of that main account identifier. In addition to the recipient IM account identifier, the IM message may also include text, images, and/or other types of media (e.g., audio, video). The sender user may send the IM message to the recipient IM account identifier without knowing whether the recipient IM account identifier is currently logged on or not.

At 204, it is determined whether the recipient IM account identifier is logged on. If the online server indicates that the recipient IM account identifier is current logged on, then at least the main account identifier may receive the IM message in approximately real-time (or as promptly as the IM message may be sent to the main account identifier) and control passes to 206. However, if the online server indicates that the recipient IM account identifier is not currently logged on, then the main account identifier may not receive the IM message in approximately real-time and control passes to 208.

To determine whether the recipient IM account identifier is logged on, the IM server queries the online server for whether the recipient IM account identifier is currently logged on to the IM service. In various embodiments, whenever a user uses an IM account identifier (regardless if the IM account identifier is a main account identifier or a sub-account identifier) to log on at an IM client, the IM server will send a logon message to the online server once the user is successful logged on. For example, the logon message may include the successfully logged on IM account identifier and the routing address of the device on which the IM client associated the IM account identifier is installed as determined during the logon process. After the online server receives the logon message, it extracts the IM account identifier and routing address from the logon message and establishes a correspondence between this IM account identifier that is now logged on and the routing address.

In various embodiments, when a logged on IM account identifier logs off, the IM server sends a withdrawal message to the online server. The withdrawal message includes at least the IM account identifier that logged off. After the online server receives the withdrawal message, it looks up the established correspondences and determines the correspondence between the logged off IM account identifier and its routing address and deletes this correspondence between the logged off IM account identifier and the routing address.

Because the online server updates the correspondences between logged on IM account identifiers and routing addresses, the online server maintains up to date records of the correspondences between IM account identifiers (both main account identifiers and sub-account identifiers) that are currently logged on and the routing addresses of the devices used by the users of these IM account identifiers. At 206, the IM message is sent to at least the recipient IM account identifier. In some embodiments, in the event that the recipient IM account identifier is currently logged on, the IM message is promptly sent to at least a device associated with the logged on recipient IM account identifier. For example, the routing address of such a device may be determined by having the IM server query the allocation server that keeps track of the routing addresses of devices installed with the IM client that users used to log on to the IM service. In some embodiments, it is further determined whether any sub-account identifiers exist under the main account identifier of the recipient IM account identifier. If it is determined that at least one sub-account identifier exists, then it is determined whether any of the sub-account identifiers are currently logged on. The IM message then may be sent to a sub-account identifier that is currently logged on in addition to the recipient IM account identifier.

At 208, it is determined whether the recipient IM account identifier is associated with a sub-account identifier. In the event that the recipient IM account identifier is associated with a sub-account identifier (i.e., a sub-account identifier has been created for the main account identifier that is the recipient IM account identifier), control passes to 212. However, in the event that the recipient IM account identifier is not associated with a sub-account identifier (i.e., a sub-account identifier has not been created for the main account identifier that is the recipient IM account identifier), control passes to 210.

To determine whether the recipient IM account identifier is a main account identifier that is associated with at least one sub-account identifier, the IM server queries the allocation server. In some embodiments, a user may set up a main account identifier with the IM client at the IM server and the IM server will send a message to the allocation server to record the creation of the new main account identifier. In some embodiments, after a user sets up the main account identifier with the IM client, the user may request of the IM server that a sub-account identifier be created under the existing main account identifier. Once the IM server successfully creates the sub-account identifier(s), the IM server sends a creation message to the allocation server. For example, the creation message may include the IM account identifier of the main account identifier and the IM account identifier(s) of the newly created sub-account identifier(s). The allocation server extracts the main account identifier and the IM sub-account identifier(s) from the creation message and records correspondences between the main account identifier and the one or more sub-account identifiers.

In 208, the IM server queries the allocation server for whether there exists an IM sub-account identifier that corresponds to a main account identifier that is the recipient IM account identifier extracted from the IM message. If the allocation server indicates to the IM server that there are no sub-account identifiers that correspond to the recipient IM account identifier, then the IM server determines that the recipient IM account identifier is both not logged on and also not associated with a sub-account identifier (i.e., no sub-account identifier has been created for the recipient IM account identifier), so at 210, the IM message is cached for the recipient IM account identifier when the recipient IM account identifier next logs on. For example, the IM server may cache the IM message in a database and monitors the online server in real time for an indication that the recipient IM account identifier has logged on. Then after the IM server determines that the recipient IM account identifier has logged on by virtue of the recipient IM account identifier appearing in the recordings of the online server, the IM server sends the cached IM message to a routing address of the device used by the user of the recipient IM account identifier. Note that sending a cached IM message to a recipient is no longer the same thing as sending the IM message promptly as would have been the case if the main account identifier were logged on at the time the IM message was sent. If the allocation server indicates to the IM server that there is at least one sub-account identifier that corresponds to the recipient IM account identifier, then control passes to 212.

At 212, it is determined whether the sub-account identifier is logged on. In the event that the sub-account identifier is logged on, control passes to 214. However, in the event that the sub-account identifier is not logged on, control passes to 210.

As mentioned above, the online server keeps track of the logon statuses of both main account identifiers and sub-account identifiers. So, in 212, the IM server uses the retrieved sub-account identifier(s) retrieved from the allocation server in 208 to query the online server for whether such sub-account identifier(s) are currently logged on. If none of such sub-account identifier(s) is currently logged on, control passes to 210, in which the IM message is cached for the recipient IM account identifier when the recipient IM account identifier next logs on. However, if at least one such sub-account identifier(s) is currently logged on, then the IM message may potentially be forwarded to the sub-account identifier as will be described in 214 and 216.

At 214, the IM message is sent to a sub-account identifier determined to be logged on. In 214, it is determined that even though the recipient IM account identifier (i.e., the main account identifier) is not logged on to promptly receive the IM message, the IM message may still be promptly sent and received by at least one logged on sub-account identifier.

In some embodiments, if only one sub-account identifier has logged on, then it is determined that the IM message is sent to that sub-account identifier at its respective routing address.

In some embodiments, if multiple sub-account identifiers corresponding to the recipient IM account identifier are logged on, then it is determined that the IM message is to be sent to at least some of the multiple sub-account identifiers at their respective routing addresses.

Below are two example techniques of selecting a subset of multiple logged on sub-account identifiers: Technique 1: Selecting sub-account identifiers based on priority levels assigned to sub-account identifiers.

In some embodiments, when the IM server creates one or more IM sub-account identifiers for the IM main account identifier, it can assign a priority level to each created IM sub-account identifier based on settings configured by the user. So, each of the multiple sub-account identifiers corresponding to one main account identifier may have a priority level assigned to it by the user that created the main account identifier. To select a subset of sub-account identifiers, the IM server may rank the logged on sub-account identifiers based on their respective priority levels. A priority level threshold may be preset such that those logged on sub-account identifiers whose priority levels meet or exceed the priority level threshold are selected to promptly receive the IM message in place of the main account identifier.

One example in which Technique 1 may be applied is as follows: Assume that the IM service is available on an e-commerce website and a buyer/customer user desires to chat with a seller user on the website about a product that the seller had advertised on his webpage. The buyer user then sends an IM message to the seller user at an IM account identifier of the seller's that was available on the seller's webpage. The seller may be a user who has created a main account identifier with the IM service to allow him to communicate with buyers and/or other interested users. To ensure that the seller's employees are also kept in the loop regarding customers' IM communications, the seller has created a separate sub-account identifier for each of his employees such that it would be possible for an employee who is logged on using the employee's own sub-account identifier to receive incoming IM messages even while the seller is offline. That way, the seller can be assured that even if he is not logged on using the main account identifier, an employee of his may still be able to receive incoming IM messages if the employee is logged on using the sub-account identifier. In creating the sub-account identifiers for his employees, the seller may assign different priority levels to the sub-account identifiers of different employees that reflect, for example, their respective titles within the company. Thus, in the event that the seller is not logged on, those of his employees who are logged on via their respective sub-account identifiers associated with priority levels higher than the threshold priority level are determined to receive the IM message sent to the seller so that the employees can help maintain customer service of the seller's online store. In such an example, the seller may preset the priority level threshold to be relatively low such that most employees' priority levels meet or exceed the threshold to guarantee a higher chance that at least one employee will be able to receive an IM message even when the seller is not logged on.

Another example in which Technique 1 may be applied is as follows: Assume that the IM service is an online conference service and an IM message has been sent to a conference attendee. The conference attendee may use the IM service via a main account identifier and the conference attendee's assistant may be assigned a separate sub-account and associated priority level. The conference attendee may preset the priority level threshold to be such that only the designated assistant's priority level meets or exceeds the threshold such that the designated assistant may be the designated recipient of the conference attendee's incoming IM messages when the conference attendee is not logged on to the IM service. As such, the preset priority level may be set to selectively permit sub-account identifier users to receive IM messages for security and/or other reasons.

Technique 2: Selecting sub-account identifiers based on how busy the sub-account identifiers are.

In some embodiments, the IM server receives each sent IM message and transfers the IM message to the appropriate IM account identifier. As such, the IM server may record when IM messages are sent, which IM account identifier sent the IM message, and which IM account identifier received the IM message in logs. Thus, the IM server may analyze such log information to determine the volume of IM messages that are sent and/or received (transferred) by each IM account identifier within a prior set period of time. The IM server may determine the volume of IM messages sent and/or received by each of logged on sub-account identifiers within the prior set period of time based on the analysis of the logs. The greater the volume of messages sent and/or received by a sub-account identifier, the busier the sub-account identifier is determined to be. The IM server may then rank the sub-account identifiers based on their respective determined volumes of IM messages and determine which sub-account identifiers are associated with respective volumes of IM messages that are below a threshold value. The sub-account identifier(s) associated with respective volumes of IM messages that are below the threshold value are considered to be relatively less busy and may be selected to receive the IM message sent to the offline (i.e., not logged on) recipient IM account identifier. Technique 2 may be used to balance the volume of processing of IM messages over the multiple logged sub-account identifiers of the recipient IM account identifier.

Once the one or more sub-account identifiers to promptly receive the IM message in place of the recipient IM account identifier are determined, the routing address(es) of the respective sub-account identifiers are determined by querying the online server. Then, the IM message is sent to the determined sub-account identifiers at their respective routing addresses. The IM message at the receiving sub-account identifiers may be viewed by users via the IM client installed at the devices.

At 216, identifying information of the sub-account identifier associated with receiving the IM message is sent to an IM account identifier associated with sending the IM message. In some embodiments, the IM account identifier(s), username, and/or any other type of identifier of the sub-account identifiers that received the IM message in place of the offline recipient IM account identifier are sent to the sending IM account identifier (e.g., at the device used by the sender user) so that the sender user becomes aware that the actual recipient of the sent IM message is a different IM account identifier than the user had selected. Generally, each IM account identifier is used by a different user, so by notifying the user of the sending IM account identifier that an IM account identifier, different than the recipient IM account identifier of the IM message, actually received the IM message, the sender user is made aware that the user to which he/she may engage in IM messaging (e.g., in a newly opened chat box) is a different user than the one that the sender user had originally intended to contact. In other words, the actual recipient and the recipient that the sender expected may be different. For example, the sender user had sent a message to a user at IM account identifier XYZ but the XYZ account was not logged on. However, a sub-account ABC to the XYZ account was currently logged on and so the ABC account promptly received the IM message intended for XYZ. As a result, the sender user may be sent the system message that indicates “ABC account identifier will communicate with you” in the chat window that is opened between the sender user and the user using IM account identifier ABC.

In some embodiments, in addition to sending identifying information of the sub-account identifier that actually received the IM message, an indication of the relationship between the recipient IM account identifier and the receiving sub-account identifier is also sent to the sender user. This is so that the sender user is made aware that while the actual recipient of the IM message is not the user associated with the recipient IM account identifier, the recipient is most likely a user that is an employee or otherwise related to the user of the recipient IM account identifier and who may also be able to address any issues that the sender user may have.

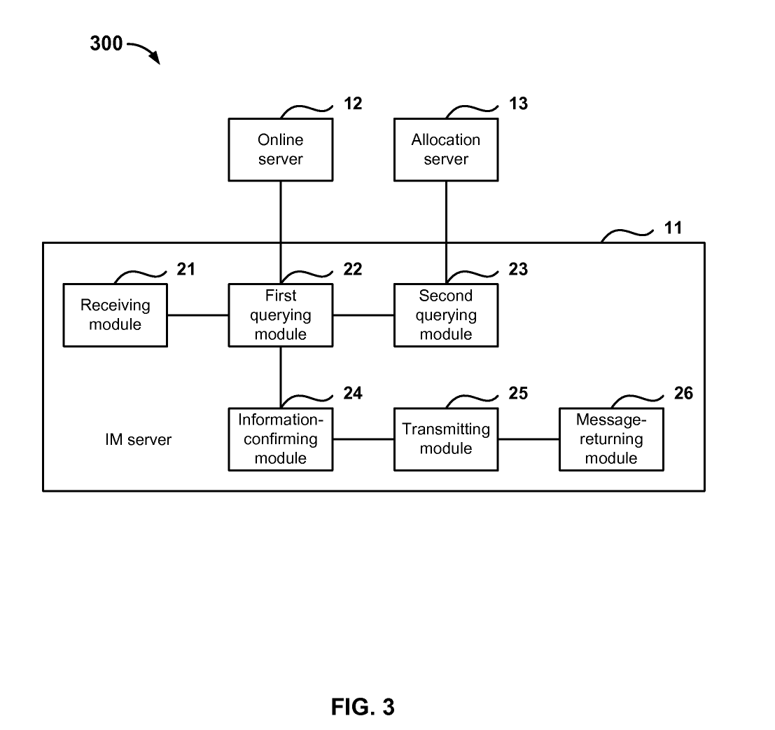

FIG. 3 is a diagram showing an embodiment of a system for transmitting IM messages to an IM account identifier. System 300 includes online server 12, allocation server 13, and IM server 11.

The modules can be implemented as software components executing on one or more processors, as hardware such as programmable logic devices and/or Application Specific Integrated Circuits designed to perform certain functions, or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices.

Online server 12 is configured to record the correspondence between a recently logged on IM account identifier and the routing address of the device on which a user of the IM account identifier used to log on to the IM service.

Allocation server 13 is configured to record each newly created IM main account identifier and its correspondence with any IM sub-account identifiers created under it.

IM server 11 further includes receiving module 21, first querying module 22, information-confirming module 24, second querying module 23, transmitting module 25, and message-returning module 26. Receiving module 21 is configured to receiving IM messages that include at least recipient IM account identifiers to which the IM messages are intended to be sent. First querying module 22 is configured to query online server 12 to determine whether the recipient IM account identifier included in the received IM message has logged on. If the recipient IM account identifier has not logged on, then first querying module 22 is configured to trigger second querying module 23 to determine whether the recipient IM account identifier is associated with a sub-account identifier and also to query whether an IM sub-account identifier corresponding to the recipient IM account identifier, if at least one exists, has logged on. Second querying module 23 is configured to query allocation server 13 to determine whether the recipient IM account identifier has a corresponding IM sub-account identifier. If the recipient IM account identifier has a corresponding IM sub-account identifier, second querying module 23 is configured to trigger first querying module 22 as to whether the IM sub-account identifier corresponding to the recipient IM account identifier is logged on. Information-confirming module 24 is configured to confirm at least one logged on IM sub-account identifier corresponding to the recipient IM account identifier and its respective routing address. Transmitting module 25 is configured to transmit the IM message to the confirmed routing address of the device on which the user of the IM sub-account identifier logged on to the IM service.

In the event that there are multiple logged on sub-account identifiers corresponding to the recipient IM account identifier, transmitting module 25 is further configured to determine a subset of such logged on sub-account identifiers to send the IM message to. In some embodiments, transmitting module 25 may determine the subset of logged on sub-account identifiers based at least in part on the priority level assigned to each of the logged on sub-account identifiers. For example, transmitting module 25 may select the logged on sub-account identifier(s) associated with respective priority levels that meet or exceed a preset priority level. In some embodiments, transmitting module 25 is configured to select the logged on sub-account identifier(s) based on how busy the sub-account identifiers are. For example, transmitting module 25 may select the logged on sub-account identifier(s) that have processed a volume of IM messages within a prior period of time below a threshold value.

IM server 11 further includes message-returning module 26, which is configured to send an identifier associated with the logged on IM sub-account identifier that received the IM message back to the IM account identifier that sent the IM message.

A person skilled in the art should understand that the embodiments of the present application can be provided as methods, systems or computer software products. Therefore, the present application can take the form of embodiments consisting entirely of hardware, embodiments consisting entirely of software, and embodiments which combine software and hardware. In addition, the present application can take the form of computer programs implemented on one or more computer-operable storage media (including but not limited to magnetic disk storage devices, CD-ROMs, and optical storage devices) containing computer program codes.

The present application is described with reference to flow charts and/or block diagrams based on methods, equipment (systems) and computer program products. It should be understood that each process and/or block in the flow charts and/or block diagrams, and combinations of processes and/or blocks in the flow charts and/or block diagrams, can be achieved through computer program commands. One can provide these computer commands to a general-purpose computer, a specialized computer, an embedded processor or the processor of other programmable data equipment so as to give rise to a machine, with the result that the commands executed through the computer or processor of other programmable data equipment give rise to a device that is used to realize the functions designated by one or more processes in a flow chart and/or one or more blocks in a block diagram.

These computer program commands can also be stored on specially-operating computer readable storage devices that can guide computers or other programmable data equipment, with the result that the commands stored on these computer readable devices give rise to products that include command devices. These command devices realize the functions designated in one or more processes in a flow chart and/or one or more blocks in a block diagram.

These computer program commands can also be loaded on to a computer or other programmable data equipment, with the result that a series of operating steps are executed on a computer or other programmable equipment so as to give rise to computer processing. In this way, the commands executed on a computer or other programmable equipment provide steps for realizing the functions designated by one or more processes in a flow chart and/or one or more blocks in a block diagram.

Although preferred embodiments of the present application have already been described, a person skilled in the art can make other modifications or revisions to these embodiments once he grasps the basic creative concept. Therefore, the attached claims are to be interpreted as including the preferred embodiments as well as all modifications and revisions falling within the scope of the present application.

Obviously, a person skilled in the art can modify and vary the present application without departing from the spirit and scope of the present application. Thus, if these modifications to and variations of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system of transmitting IM messages, comprising:
one or more processors configured to:
receive an instant messaging (IM) message including a recipient IM account identifier, wherein the recipient IM account identifier comprises a main account identifier;
determine that the recipient IM account identifier is not logged on;
determine whether the recipient IM account identifier is associated with a sub-account identifier;
in the event that the recipient IM account identifier is associated with the sub-account identifier, determine whether the sub-account identifier is logged on; and
in the event that the sub-account identifier is logged on, send the IM message to the sub-account identifier and send identifying information of the sub-account identifier associated with receiving the IM message to an IM account identifier associated with sending the IM message; and
one or more memories coupled to the one or more processors and configured to provide the one or more processors with instructions.

2. The system of claim 1, wherein in the event that the recipient IM account identifier is not associated with the sub-account identifier, the one or more processors are further configured to cache the IM message until the recipient IM account identifier logs on next.

3. The system of claim 1, wherein the recipient IM account identifier is determined to be not logged on based on querying records associated with current logon statuses of IM account identifiers associated with an IM service.

4. The system of claim 1, wherein the sub-account identifier is determined to be logged on based on querying records associated with current logon statuses of IM account identifiers associated with an IM service.

5. The system of claim 1, wherein the recipient IM account identifier is determined to be associated with the sub-account identifier based on querying records associated with correspondences between main account identifiers and associated sub-account identifiers.

6. The system of claim 1, wherein the sub-account identifier is selected from a plurality of logged on sub-account identifiers corresponding to the recipient IM account identifier.

7. The system of claim 6, wherein selecting the sub-account identifier from the plurality of logged on sub-account identifiers includes determining respective priority levels associated with the plurality of logged on sub-account identifiers and selecting the sub-account identifier based on association with a priority level that meets a preset priority level threshold.

8. The system of claim 6, wherein selecting the sub-account identifier from the plurality of logged on sub-account identifiers includes determining respective volumes of IM messages transferred in a prior set period of time associated with the plurality of logged on sub-account identifiers and selecting the sub-account identifier based on association with a volume of IM messages sent and/or received below a threshold value.

9. The system of claim 1, wherein to send the IM message to the sub-account identifier includes determining a routing address associated with a device on which a user associated with the sub-account identifier used to perform logon.

10. A method of transmitting IM messages, comprising:
receiving an instant messaging (IM) message including a recipient IM account identifier, wherein the recipient IM account identifier comprises a main account identifier;
determining that the recipient IM account identifier is not logged on;
determining whether the recipient IM account identifier is associated with a sub-account identifier;
in the event that the recipient IM account identifier is associated with the sub-account identifier, determining whether the sub-account identifier is logged on; and
in the event that the sub-account identifier is logged on, sending the IM message to the sub-account identifier and sending identifying information of the sub-account identifier associated with receiving the IM message to an IM account identifier associated with sending the IM message.

11. The method of claim 10, wherein in the event that the recipient IM account identifier is not associated with the sub-account identifier, further comprising caching the IM message until the recipient IM account identifier logs on next.

12. The method of claim 10, wherein the recipient IM account identifier is determined to be not logged on based on querying records associated with current logon statuses of IM account identifiers associated with an IM service.

13. The method of claim 10, wherein the sub-account identifier is determined to be logged on based on querying records associated with current logon statuses of IM account identifiers associated with an IM service.

14. The method of claim 10, wherein the recipient IM account identifier is determined to be associated with the sub-account identifier based on querying records associated with correspondences between main account identifiers and associated sub-account identifiers.

15. The method of claim 10, wherein the sub-account identifier is selected from a plurality of logged on sub-account identifiers corresponding to the recipient IM account identifier.

16. The method of claim 15, wherein selecting the sub-account identifier from the plurality of logged on sub-account identifiers includes determining respective priority levels associated with the plurality of logged on sub-account identifiers and selecting the sub-account identifier based on association with a priority level that meets a preset priority level threshold.

17. The method of claim 15, wherein selecting the sub-account identifier from the plurality of logged on sub-account identifiers includes determining respective volumes of IM messages sent and/or received in a prior set period of time associated with the plurality of logged on sub-account identifiers and selecting the sub-account identifier based on association with a volume of IM messages sent and/or received below a threshold value.

18. The method of claim 10, wherein to send the IM message to the sub-account identifier includes determining a routing address associated with a device on which a user associated with the sub-account identifier used to perform logon.

19. A computer program product for transmitting IM messages, the computer program product being embodied in a computer readable storage medium and comprising computer instructions for:
receiving an instant messaging (IM) message including a recipient IM account identifier, wherein the recipient IM account identifier comprises a main account identifier;
determining that the recipient IM account identifier is not logged on;
determining whether the recipient IM account identifier is associated with a sub-account identifier;
in the event that the recipient IM account identifier is associated with the sub-account identifier, determining whether the sub-account identifier is logged on; and
in the event that the sub-account identifier is logged on, sending the IM message to the sub-account identifier and sending identifying information of the sub-account identifier associated with receiving the IM message to an IM account identifier associated with sending the IM message.
